(19) United States
(12) Patent Application Publication
(10) Pub. No.: US 2012/0098462 A1
(43) Pub. Date: Apr. 26, 2012

(54) LED Driver Circuit, Light Source Device, And LCD Device

(75) Inventors: Naoto Inoue, Osaka (JP); Akira Tomiyoshi, Osaka (JP); Takeshi Masuda, Osaka (JP); Yuhsaku Ajichi, Osaka (JP)

(73) Assignee: SHARP KABUSHIKI KAISHA, Osaka-shi, Osaka (JP)

(21) Appl. No.: 13/379,578

(22) PCT Filed: Apr. 14, 2010
(86) PCT No.: PCT/JP2010/002701

§ 371 Date: Dec. 20, 2011

(30) Foreign Application Priority Data
Oct. 29, 2009 (JP) 2009-249008

(51) Int. Cl. H05B 37/02

(52) U.S. Cl. 315/297

(57) ABSTRACT

An LED driver circuit which provides a cost reduction is provided by employing a circuit configuration which allows a size reduction. In at least one example embodiment, the LED driver circuit includes a first switching element, a second switching element, a sense resistor, a sensing unit, a calculator, and a driver. The plurality of LEDs, the first switching element, the second switching element, and the sense resistor are coupled to each other in series in this order. The sensing unit receives a voltage at a node between the second switching element and the sense resistor, and generates voltage data representing the voltage. The calculator calculates a temporal average of a current flowing through the LEDs based on the voltage data, and generates current data corresponding to the temporal average. The driver drives the first switching element and the second switching element based on the current data.

### TECHNICAL FIELD

The present disclosure relates to LED driver circuits, light source devices, and liquid crystal display (LCD) devices.

### BACKGROUND ART

In recent years, light emitting diodes (LEDs) have been actively employed in place of conventional cold cathode fluorescent lamps in, for example, backlight units which are light sources of LCD devices.

When LEDs are connected in series in a backlight unit which employs the LEDs as light sources, a constant current circuit needs to be provided in an LED driver circuit to supply a constant stable current to the LEDs. Patent Document 1 describes conventional

LED driver circuits which do not use sense resistors. Patent Document 2 describes a method for feeding back an LED current by a differential amplifier.

### CITATION LIST

### Patent Document

PATENT DOCUMENT 1: Japanese Patent Publication No. 2001-326569

PATENT DOCUMENT 2: Japanese Patent Publication No. 2009-070878

### SUMMARY OF THE INVENTION

### Technical Problem

However, the conventional examples described in the patent documents described above have problems in that a transistor generates a significant amount of heat, and that circuits are complex. In addition, a switching constant current circuit performs switching, for example, between a ground potential and the potential of a voltage input unit, thereby requiring a smoothing circuit to smooth an LED current. However, this smoothing circuit requires both a wire-wound inductor having a relatively high inductance and a capacitor having a relatively high capacitance. Thus, a small-sized inductor and a small-sized capacitor cannot be applied in such a smoothing circuit. This results in a problem in that circuit integration is difficult, and that a circuit size reduction is also difficult.

The present invention has been made in view of these problems, and it is an object of the present invention to reduce product costs by employing a circuit configuration which allows a size reduction.

### Solution to the Problem

According to an embodiment of the present invention, a light emitting diode (LED) driver circuit for driving a plurality of LEDs includes a first switching element, a second switching element, a sense resistor, a sensing unit, a calculator, and a driver, where the plurality of LEDs, the first switching element, the second switching element, and the sense resistor are coupled to each other in series in this order, the sensing unit receives a voltage at a node between the second switching element and the sense resistor, and generates voltage data representing the voltage, the calculator calculates a temporal average of a current flowing through the plurality of LEDs based on the voltage data, and generates current data corresponding to the temporal average, and the driver drives the first switching element and the second switching element based on the current data.

According to the configuration described above, the state of the LED driver circuit can be switched between three states: the two switching elements are turned off, only one of the switching elements is turned on, and the two switching elements are turned on; thus, the average current flowing through the LEDs can be adjusted so as to be a desired current value. This allows the current value to be set within a smaller range than in a conventional circuit having only two states which are ON and OFF.

A variation of the LED driver circuit according to an embodiment of the present invention further includes a smoothing circuit coupled to the plurality of LEDs and having an inductor and a capacitor.

According to the configuration described above, rectangular waves generated by the switching elements are smoothed, thereby allowing noise generation to be reduced.

A variation of the LED driver circuit according to an embodiment of the present invention includes a plurality of units each having the plurality of LEDs, the first switching element, the second switching element, and the sense resistor, and the sensing unit is time shared by the plurality of units.

According to the configuration described above, one analog-to-digital converter (ADC) can be shared between a plurality of driver units. Such a configuration provides a cost reduction in the LED driver circuit.

According to an embodiment of the present invention, an LED driver circuit for driving a plurality of LEDs includes a first switching element, a second switching element, a first sense resistor, a second sense resistor, a sensing unit, a calculator, and a driver, where the first switching element and the first sense resistor are coupled to each other in series to form a first unit, the second switching element and the second sense resistor are coupled to each other in series to form a second unit, the first unit and the second unit are coupled to each other in parallel to form a third unit, the plurality of LEDs and the third unit are coupled to each other in series, the sensing unit receives a first voltage at a node between the first switching element and the first sense resistor, and generates first voltage data representing the first voltage, the sensing unit receives a second voltage at a node between the second switching element and the second sense resistor, and generates second voltage data representing the second voltage, the calculator calculates a temporal average of a current flowing through the plurality of LEDs based on the first voltage data and on the second voltage data, and generates current data corresponding to the temporal average, and the driver drives the first switching element and the second switching element based on the current data.

According to the configuration described above, the state of the LED driver circuit can be switched between four states: the two switching elements are turned off, only the first switching elements is turned on, only the second switching elements is turned on, and the two switching elements are turned on; thus, the average current flowing through the LEDs can be adjusted so as to be a desired current value. This allows the current value to be set within a smaller range than in a conventional circuit having only two states which are ON and OFF.

According to an embodiment of the present invention, a light source device includes a plurality of LEDs, and the LED driver circuit for driving the plurality of LEDs.

According to the configuration described above, the light source device can set the current value within a smaller range by an operation of the LED driver circuit.

According to an embodiment of the present invention, a liquid crystal display (LCD) device includes a plurality of LEDs, the LED driver circuit for driving the plurality of LEDs, and an LCD panel disposed opposite the plurality of LEDs.

According to the configuration described above, the LCD device can set the current value within a smaller range by an operation of the LED driver circuit.

### ADVANTAGES OF THE INVENTION

According to the present invention, the average forward current flowing through the LEDs can reach or approach a constant target value, and if a smoothing circuit is provided, the inductor and the capacitor included in the smoothing circuit can both be reduced in size. As a result, product costs can be reduced by employing a circuit configuration which allows a size reduction.

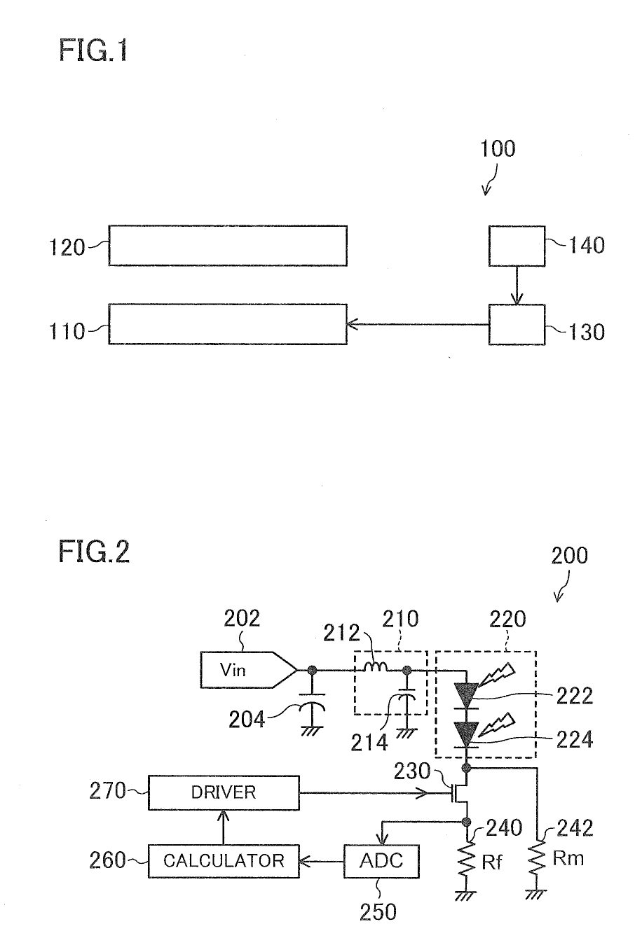

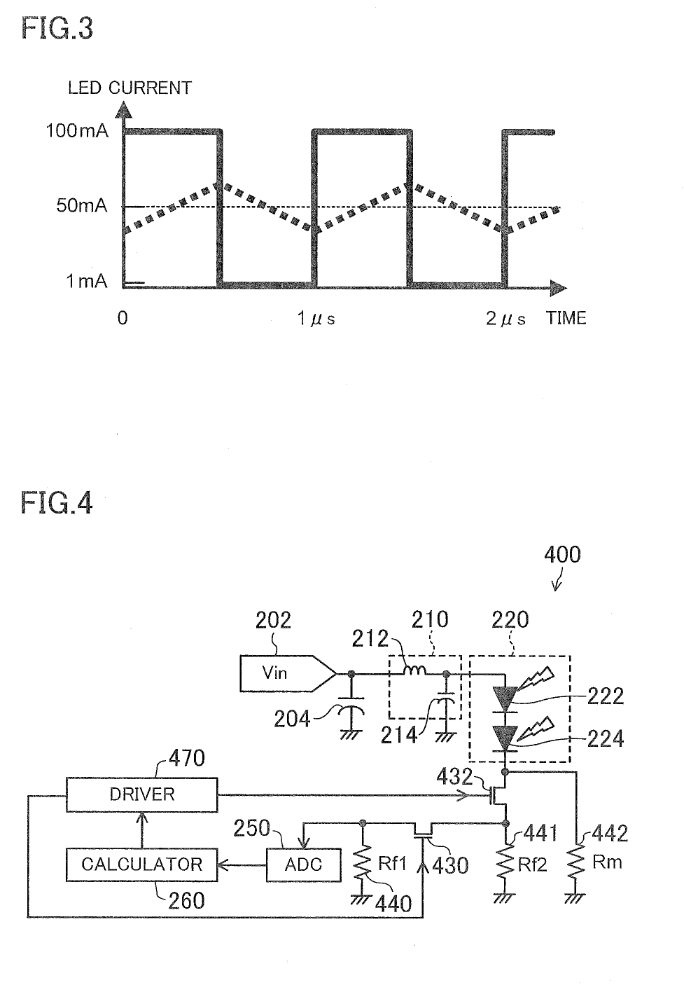

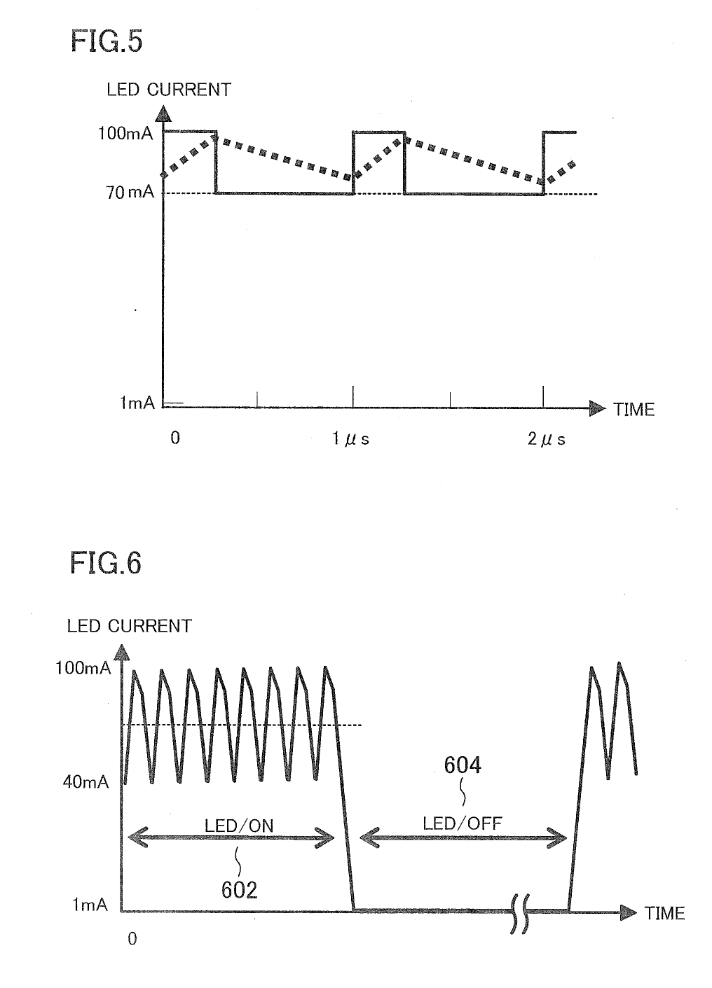

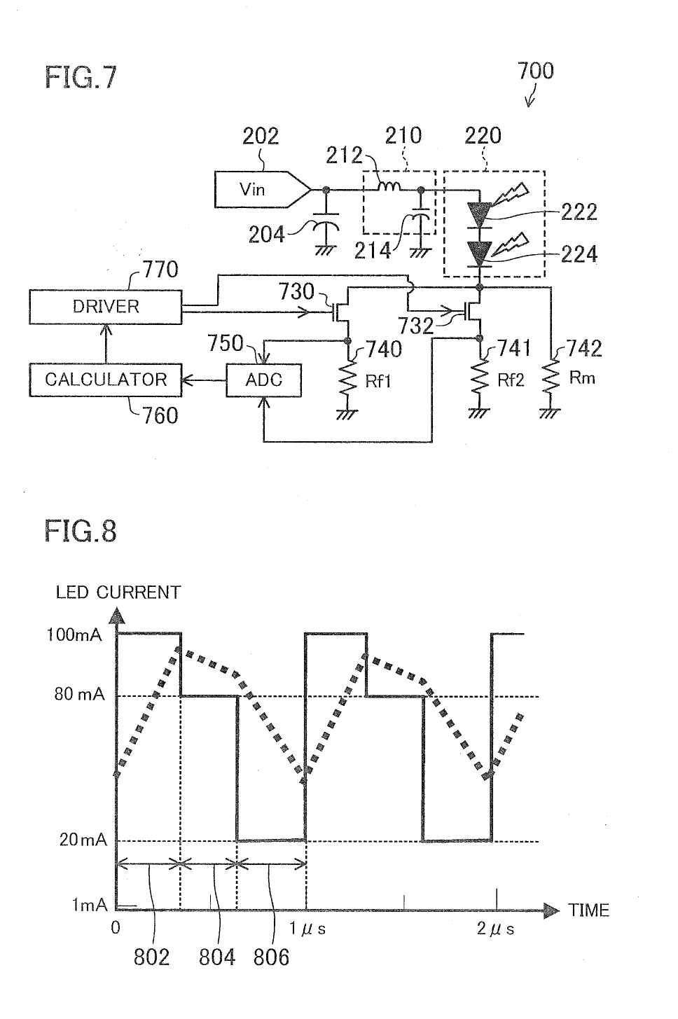

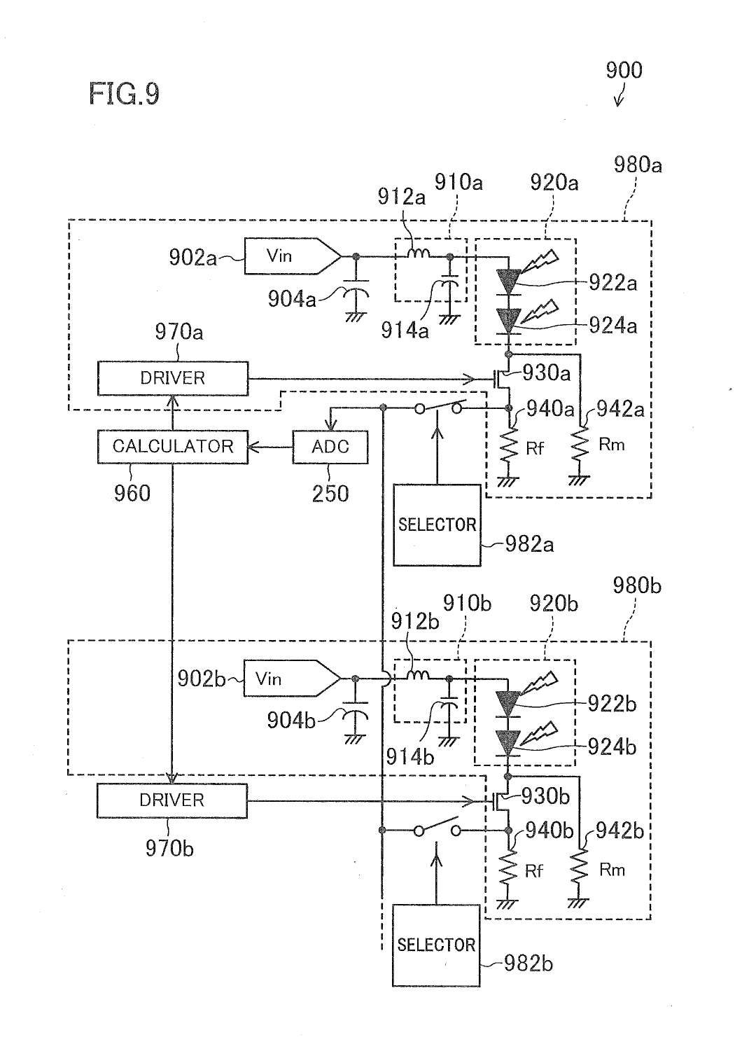

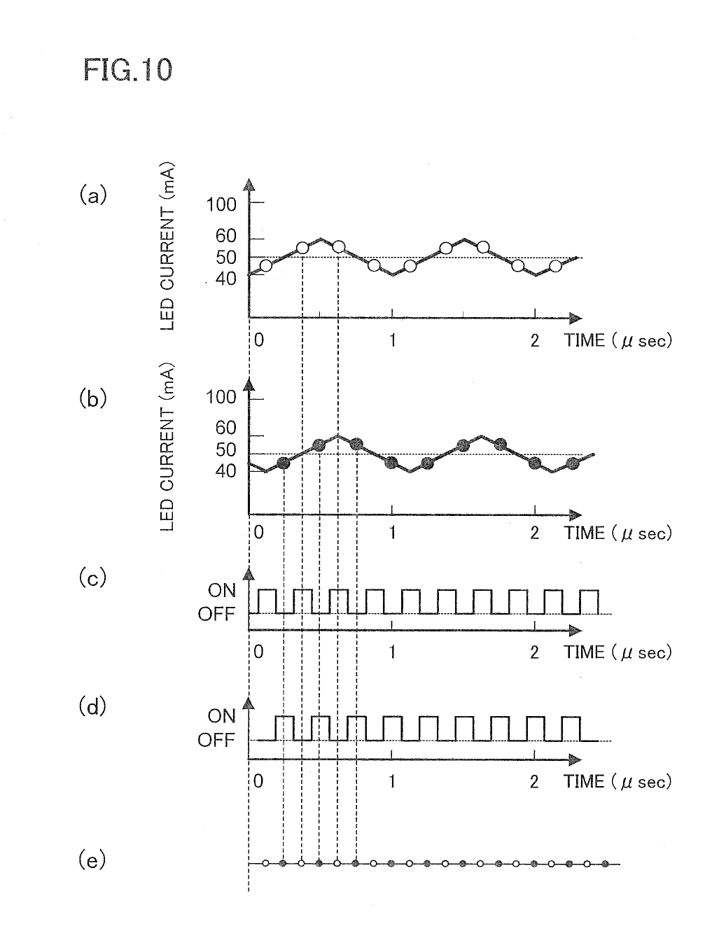

### BRIEF DESCRIPTION OF THE DRAWINGS

[FIG. 1] FIG. 1 is a schematic diagram of an LCD device using an LED driver circuit according to an example embodiment of the present invention.

[FIG. 2] FIG. 2 is a circuit diagram of an LED driver circuit according to an embodiment of the present invention.

[FIG. 3] FIG. 3 is a waveform diagram of a current flowing through the LEDs.

[FIG. 4] FIG. 4 is a circuit diagram of an LED driver circuit according to another embodiment of the present invention.

[FIG. 5] FIG. 5 is a waveform diagram of a current flowing through the LEDs.

[FIG. 6] FIG. 6 is a waveform diagram of a current flowing through the LEDs in an example including a state in which the switching elements are both turned off.

[FIG. 7] FIG. 7 is a circuit diagram of an LED driver circuit according to still another embodiment of the present invention.

[FIG. 8] FIG. 8 is a waveform diagram of a current flowing through the LEDs.

[FIG. 9] FIG. 9 is a circuit diagram of an LED driver circuit according to still another embodiment of the present invention.

[FIG. 10] FIG. 10 is a waveform diagram illustrating an operation of an LED driver circuit.

### DESCRIPTION OF EMBODIMENTS

Components providing a same or an equivalent function herein are designated by a same reference numeral. Components designated by reference numerals having the same last two digits correspond to one another.

In this specification, the term “couple” refers to a direct or indirect electrical connection. Accordingly, other components may exist between two components coupled to each other.

(Overview of LCD Device)

FIG. 1 is a schematic diagram of an LCD device 100 using an LED driver circuit according to an example embodiment of the present invention. The LCD device 100 includes a backlight unit 110, an LCD panel 120, and an LED driver circuit 130. The backlight unit 110 is disposed opposite the LCD panel 120. A user of the LCD device 100 sees the light emitted by the backlight unit 110 through the LCD panel 120.

The LCD panel 120 typically includes a thin film transistor (TFT) substrate as an active matrix substrate, an opposing substrate disposed opposite to the TFT substrate, and a liquid crystal layer provided between the TFT substrate and the opposing substrate. The LCD panel 120 is divided into many small display regions. The display regions are organized into columns and rows of a matrix. Each of the display regions corresponds to a pixel. In each of the pixels, a TFT and a pixel electrode connected thereto are foamed. Pixel is the smallest unit of display in the LCD panel 120.

The backlight unit 110 includes a plurality of LEDs. The LED driver circuit 130 drives the LEDs. Specifically, the LED driver circuit 130 controls the current supplied from a power supply 140 to the LEDs. The LEDs of the backlight unit 110 emit light at a brightness level depending on the controlled current. The LCD panel 120 displays a desired image by transmitting the light emitted by the backlight unit 110.

In this specification, the combination of the backlight unit 110, including the LEDs, and the LED driver circuit 130 is referred to as light source device.

(Configuration of LED Driver Circuit 200)

FIG. 2 is a circuit diagram of an LED driver circuit 200 according to an embodiment of the present invention. The LED driver circuit 200 receives a supply voltage Vin at a power supply node 202. A capacitor 204 is provided between the power supply node 202 and ground. The power supply node 202 is coupled to a light emitting unit 220 through a smoothing circuit 210.

The smoothing circuit 210 includes an inductor 212 and a capacitor 214. In this embodiment, a switching operation of a switching element 230 described later allows the inductance of the inductor 212 and the capacitance of the capacitor 214 to be low. A variation of this embodiment does not necessarily need to include the smoothing circuit 210.

The light emitting unit 220 includes LEDs 222 and 224 connected in series. The light sources of the light emitting unit 220 are not limited to LEDs, but may be any light emitting devices.

The switching element 230 is typically a field effect transistor (FET). The switching element 230 is, for example, a power metal oxide semiconductor FET (MOSFET). In this embodiment, the switching element 230 is an n-channel FET, but is not limited thereto, and may be a p-channel FET. The cathode side of the LED 224 is coupled to the drain of the switching element 230. The source of the switching element 230 is coupled to ground through a sense resistor 240 (resistance value: Rf). The drain of the switching element 230 is coupled to ground through a resistor 242 (resistance value: Rm).

The source of the switching element 230 is coupled to an input of an ADC 250. The ADC 250 receives an input voltage, generates voltage data representing this voltage, and outputs the voltage data to a calculator 260. Typically, the voltage data represents a voltage in an 8-bit linear format, but the representation format is not limited thereto. Rather, the voltage may be represented using any suitable method.

The calculator 260 calculates a temporal average of a current (simply referred to herein as “average current”) flowing through the LEDs 222 and 224 based on the voltage data generated by the ADC 250, generates current data representing this average current, and outputs the current data to a driver 270. Typically, the current data represents an average current in an 8-bit linear format, but the representation format is not limited thereto. Rather, the average current may be represented using any suitable method. Thus, the calculator 260 functions as an average current computing unit.

The driver 270 provides pulse width modulation (PWM) control. Specifically, the driver 270 drives the switching element 230 based on the current data generated by the calculator 260. Thus, the driver 270 functions as a PWM control unit.

(Operation of LED Driver Circuit 200)

FIG. 3 is a waveform diagram of a current flowing through the LEDs 222 and 224. In FIG. 3, the solid line represents an LED current in a configuration without the smoothing circuit 210, and the dotted line represents an LED current in a configuration with the smoothing circuit 210. In FIG. 3, the driver 270 drives the switching element 230 at a frequency of 1 MHz and with a duty cycle of 50%. In this specification, the term duty cycle refers to a ratio of an ON time to the sum of an ON time and an OFF time.

The switching element 230 performs a switching operation which selects either an ON state (conducting state) or an OFF state (non-conducting state). In other words, the switching element 230 operates so as to pass through the non-saturation region as quickly as possible, and conducts in the saturation region. Such an operation minimizes the loss due to the switching element 230.

In this embodiment, the current value of the LEDs 222 and 224 can be set to two values depending on whether the switching element 230 is in an ON state or an OFF state.

Here, the component values are determined as follows. The resistors 240 and 242 have resistance values of Rf and Rm, respectively. A standby current, which flows through the LEDs 222 and 224 when the switching element 230 is in an OFF state, is Isb (1 mA), and the forward voltage Vf in this situation is Vf(Isb). An ON current, which flows through the LEDs 222 and 224 when the switching element 230 is in an ON state, is Ion (100 mA), and the forward voltage Vf in this situation is Vf(Ion). The total resistance of the resistors 240 and 242 in a parallel connection is Rtt=Rf//Rm=Rm (because Rm is larger than Rf). Determining the component values as described above yields the following equations:

Vin=Vf(Isb)+Isb·Rm (1)

Vin=Vf(Ion)+Ion·Rtt (2)

In general, the forward voltage of an LED varies from part to part, and also varies depending on a current flowing therethrough. According to Equations 1 and 2, even if the supply voltage Vin is constant, appropriately selecting the values of two different currents, that is, the standby current Isb and the ON current Ion, allows a desired average current to flow through the LEDs 222 and 224.

Specifically, the driver 270 changes the duty cycle based on the average current obtained by the calculator 260 so that the temporal average of the current flowing through the LEDs 222 and 224 becomes a desired value.

For example, if the value of the average current obtained by the calculator 260 is lower than a target value, the driver 270 increases the ON time and reduces the OFF time of the switching element 230 by means of PWM control. Thus, the average current increases and approaches the target value.

Conversely, if the value of the average current obtained by the calculator 260 is higher than a target value, the driver 270 reduces the ON time and increases the OFF time of the switching element 230 by means of PWM control. Thus, the average current decreases and approaches the target value.

Thus, irrespective of whether the average current of the LEDs is higher or lower than a target value, the driver 270 controls the switching element 230 so that the average current of the LEDs approaches closer to the target value. This allows the average current of the LEDs 222 and 224 to be maintained constant even when the forward voltage Vf of the LEDs 222 and 242 changes due to variation from part to part and due to the current flowing through the LEDs. Accordingly, this embodiment allows the inductance of the inductor 212 and the capacitance of the capacitor 214 to be low. This reduction achieves size reductions of the inductor 212 and of the capacitor 214, thereby further allowing a size reduction of the LED driver circuit 200. In addition, reductions in the inductance and in the capacitance also provide cost reductions in the inductor 212 and in the capacitor 214.

Further, a variation of this embodiment allows the smoothing circuit 210 to be omitted. Such an approach allows a reduction in the number of parts, thereby providing a cost reduction.

(Configuration of LED Driver Circuit 400)

FIG. 4 is a circuit diagram of an LED driver circuit 400 according to another embodiment of the present invention. The LED driver circuit 400 receives a supply voltage Vin at a power supply node 202. A capacitor 204 is provided between the power supply node 202 and ground. The power supply node 202 is coupled to a light emitting unit 220 through a smoothing circuit 210.

The smoothing circuit 210 includes an inductor 212 and a capacitor 214. In this embodiment, switching operations of switching elements 430 and 432 described later allow the inductance of the inductor 212 and the capacitance of the capacitor 214 to be low. A variation of this embodiment does not necessarily need to include the smoothing circuit 210. The light emitting unit 220 includes LEDs 222 and 224 connected in series. The light sources of the light emitting unit 220 are not limited to LEDs, but may be any light emitting devices.

The switching elements 430 and 432 are typically FETs. The switching elements 430 and 432 are, for example, power MOSFETs. In this embodiment, the switching elements 430 and 432 are n-channel FETs, but are not limited thereto, and may be p-channel

FETs. The cathode side of the LED 224 is coupled to the drain of the switching element 432. The source of the switching element 432 is coupled to ground through a sense resistor 441 (resistance value: Rf2). The source of the switching element 432 is also coupled to the drain of the switching element 430. The source of the switching element 430 is coupled to ground through a sense resistor 440 (resistance value: RM. The drain of the switching element 432 is coupled to ground through a resistor 442 (resistance value: Rm). Grounding through the resistor 442 allows the breakdown voltage of the transistor to be lowered.

The source of the switching element 430 is coupled to an input of an ADC 250. The ADC 250 receives an input voltage, generates voltage data representing this voltage, and outputs the voltage data to a calculator 260. Typically, the voltage data represents a voltage in an 8-bit linear format, but the representation format is not limited thereto. Rather, the voltage may be represented using any suitable method.

The calculator 260 calculates a temporal average of a current (simply referred to herein as “average current”) flowing through the LEDs 222 and 224 based on the voltage data generated by the ADC 250, generates current data representing this average current, and outputs the current data to a driver 470. Typically, the current data represents an average current in an 8-bit linear format, but the representation format is not limited thereto. Rather, the average current may be represented using any suitable method. Thus, the calculator 260 functions as an average current computing unit.

The driver 470 provides PWM control. Specifically, the driver 470 drives the switching elements 430 and 432 based on the current data generated by the calculator 260. Thus, the driver 470 functions as a PWM control unit.

(Operation of LED Driver Circuit 400)

FIG. 5 is a waveform diagram of a current flowing through the LEDs 222 and 224. In FIG. 5, the solid line represents an LED current in a configuration without the smoothing circuit 210, and the dotted line represents an LED current in a configuration with the smoothing circuit 210. In FIG. 5, the driver 470 drives the switching elements 430 and 432 at a frequency of 1 MHz. In FIG. 5, the switching elements 430 and 432 are in an ON state while the LED current is 100 mA, and only the switching element 432 is in an ON state while the LED current is 70 mA. Thus, the driver 470 drives the switching element 430 with a duty cycle of 25%, and drives the switching element 432 with a duty cycle of 100%.

The switching elements 430 and 432 each perform a switching operation which selects either an ON state (conducting state) or an OFF state (non-conducting state). In other words, the switching elements 430 and 432 operate so as to pass through the non-saturation region as quickly as possible, and conduct in the saturation region. Such an operation minimizes the losses due to the switching elements 430 and 432.

In this embodiment, the current value of the LEDs 222 and 224 can be set to three values depending on whether each of the switching elements 430 and 432 is in an ON state or an OFF state.

Here, the component values are determined as follows. The resistors 440, 441, and 442 have resistance values of Rf1, Rf2, and Rm, respectively. A standby current, which flows through the LEDs 222 and 224 when the switching elements 430 and 432 are both in an OFF state, is Isb (1 mA), and the forward voltage Vf in this situation is Vf(Isb). An ON current which flows through the LEDs 222 and 224 when only the switching element 432 is in an ON state is Ion1 (70 mA), and the forward voltage Vf in this situation is Vf(Ion1). An ON current which flows through the LEDs 222 and 224 when the switching elements 430 and 432 are both in an ON state is Ion2 (100 mA), and the forward voltage Vf in this situation is Vf(Ion2). The total resistance of the resistors 440 and 441 in a parallel connection is Rtt1=Rf1//Rf2. The total resistance of the resistors 441 and 442 in a parallel connection is Rtt2=Rf2 (because Rm is larger than Rf2). Determining the component values as described above yields the following equations:

Vin=Vf(Isb)+Isb·Rm (3)

Vin=Vf(Ion1)+Ion1·Rtt2 (4)

Vin=Vf(Ion2)+Ion2·Rtt1 (5)

In general, the forward voltage of an LED varies from part to part, and also varies depending on a current flowing therethrough. According to Equations 3-5, even if the supply voltage Vin is constant, appropriately selecting the values of three different currents, that is, the standby current Isb and the ON currents Ion1 and Ion2, allows a desired average current to flow through the LEDs 222 and 224.

Specifically, the driver 470 changes the duty cycle based on the average current obtained by the calculator 260 so that the temporal average of the current flowing through the LEDs 222 and 224 becomes a desired value.

For example, if the value of the average current obtained by the calculator 260 is lower than a target value, the driver 470 increases the ON time and reduces the OFF time of the switching element 430 by means of PWM control. Thus, the average current increases and approaches the target value.

Conversely, if the value of the average current obtained by the calculator 260 is higher than a target value, the driver 470 reduces the ON time and increases the OFF time of the switching element 430 by means of PWM control. Thus, the average current decreases and approaches the target value.

Thus, irrespective of whether the average current of the LEDs is higher or lower than a target value, the driver 470 controls the switching elements 430 and 432 so that the average current of the LEDs approaches closer to the target value. This allows the average current of the LEDs 222 and 224 to be maintained constant even when the forward voltage Vf of the LEDs 222 and 242 changes due to variation from part to part and due to the current flowing through the LEDs. Accordingly, this embodiment allows the inductance of the inductor 212 and the capacitance of the capacitor 214 to be low. This reduction achieves size reductions of the inductor 212 and of the capacitor 214, thereby further allowing a size reduction of the LED driver circuit 400. In addition, reductions in the inductance and in the capacitance also provide cost reductions in the inductor 212 and in the capacitor 214.

Further, a variation of this embodiment allows the smoothing circuit 210 to be omitted. Such an approach allows a reduction in the number of parts, thereby providing a cost reduction.

FIG. 6 is a waveform diagram of a current flowing through the LEDs 222 and 224 in an example including a state in which the switching elements 430 and 432 are both turned off During a period 604, the switching elements 430 and 432 are both turned off, while during a period 602, the switching elements 430 and 432 are controlled, for example, as shown in FIG. 5 so that the value of the current flowing through the LEDs 222 and 224 alternates between two values.

As described above, the LED driver circuit 400 shown in FIG. 4 can set three current values. Thus, assuming that one of the currents is the standby current, the average current in an LED lighting condition (i.e., a condition in which a current higher than the standby current flows through the LEDs) can be set by the other two values. Accordingly, the LED driver circuit 400 is advantageous in that it can set the current value within a smaller range than the LED driver circuit 200.

(Configuration of LED Driver Circuit 700)

FIG. 7 is a circuit diagram of an LED driver circuit 700 according to still another embodiment of the present invention. The LED driver circuit 700 receives a supply voltage Vin at a power supply node 202. A capacitor 204 is provided between the power supply node 202 and ground. The power supply node 202 is coupled to a light emitting unit 220 through a smoothing circuit 210.

The smoothing circuit 210 includes an inductor 212 and a capacitor 214. In this embodiment, switching operations of switching elements 730 and 732 described later allow the inductance of the inductor 212 and the capacitance of the capacitor 214 to be low. A variation of this embodiment does not necessarily need to include the smoothing circuit 210.

The light emitting unit 220 includes LEDs 222 and 224 connected in series. The light sources of the light emitting unit 220 are not limited to LEDs, but may be any light emitting devices.

The switching elements 730 and 732 are typically FETs. The switching elements 730 and 732 are, for example, power MOSFETs. In this embodiment, the switching elements 730 and 732 are n-channel FETs, but are not limited thereto, and may be p-channel FETs. The cathode side of the LED 224 is coupled to the drains of the switching elements 730 and 732. The sources of the switching elements 730 and 732 are coupled to ground respectively through sense resistors 740 (resistance value: Rf1) and 741 (resistance value: Rf2). The drains of the switching elements 730 and 732 are coupled to ground through a resistor 742 (resistance value: Rm).

The sources of the switching elements 730 and 732 are coupled to two inputs of an ADC 750. The ADC 750 receives the two input voltages, generates two sets of voltage data representing these voltages, and outputs the voltage data to a calculator 760. Typically, the voltage data represents voltages in an 8-bit linear format, but the representation format is not limited thereto. Rather, the voltages may be represented using any suitable method.

The calculator 760 calculates a temporal average of a current (simply referred to herein as “average current”) flowing through the LEDs 222 and 224 based on the two sets of voltage data generated by the ADC 750, generates current data representing this average current, and outputs the current data to a driver 770. The two sets of voltage data generated by the ADC 750 respectively represent the products of the resistance values of the sense resistors 740 and 741 and the values of the currents flowing through the respective sense resistors 740 and 741. Thus, since the resistance values Rf1 and Rf2 are known, the current values of the sense resistors 740 and 741 can be calculated. Typically, the current data represents an average current in an 8-bit linear format, but the representation format is not limited thereto. Rather, the average current may be represented using any suitable method. Thus, the calculator 760 functions as an average current computing unit.

The driver 770 provides PWM control. Specifically, the driver 770 drives the switching elements 730 and 732 based on the current data generated by the calculator 760. Thus, the driver 770 functions as a PWM control unit.

(Operation of LED Driver Circuit 700)

FIG. 8 is a waveform diagram of a current flowing through the LEDs 222 and 224. In FIG. 8, the solid line represents an LED current in a configuration without the smoothing circuit 210, and the dotted line represents an LED current in a configuration with the smoothing circuit 210. In FIG. 8, the driver 770 drives the switching elements 730 and 732 at a frequency of 1 MHz. In FIG. 8, in a period 802 during which the LED current is 100 mA, both the switching elements 730 and 732 are in an ON state. In a period 804 during which the LED current is 80 mA, only the switching element 732 is in an ON state. In a period 806 during which the LED current is 20 mA, only the switching element 730 is in an ON state. In this case, Rf1>Rf2=Rf1/4. For example, assuming that the length of the period 802=the length of the period 804=30% of one cycle, and the length of the period 806=40% of one cycle, the driver 770 drives the switching element 730 with a duty cycle of 60% (=30%+30%), and drives the switching element 732 with a duty cycle of 70% (=30%+40%).

The switching elements 730 and 732 each perform a switching operation which selects either an ON state (conducting state) or an OFF state (non-conducting state). In other words, the switching elements 730 and 732 operate so as to pass through the non-saturation region as quickly as possible, and conduct in the saturation region. Such an operation minimizes the losses due to the switching elements 730 and 732.

In this embodiment, the current value of the LEDs 222 and 224 can be set to four values depending on whether each of the switching elements 730 and 732 is in an ON state or an OFF state.

Here, the component values are determined as follows. The resistors 740, 741, and 742 have resistance values of Rf1, Rf2, and Rm, respectively. A standby current, which flows through the LEDs 222 and 224 when the switching elements 730 and 732 are both in an OFF state, is Isb (1 mA), and the forward voltage Vf in this situation is Vf(Isb). An ON current which flows through the LEDs 222 and 224 when the switching elements 730 and 732 are both in an ON state is Ion1 (100 mA), and the forward voltage Vf in this situation is Vf(Ion1). An ON current which flows through the LEDs 222 and 224 when only the switching element 732 is in an ON state is Ion2 (80 mA), and the forward voltage Vf in this situation is Vf(Ion2). An ON current which flows through the LEDs 222 and 224 when only the switching element 730 is in an ON state is Ion3 (20 mA), and the forward voltage Vf in this situation is Vf(Ion3). The total resistance of the resistors 740 and 741 in a parallel connection is Rtt1=Rf1//Rf2. The total resistance of the resistors 741 and 742 in a parallel connection is Rtt2=Rf2 (because Rm is larger than Rf2). The total resistance of the resistors 740 and 742 in a parallel connection is Rtt3=Rf1 (because Rm is larger than Rf1).

Determining the component values as described above yields the following equations:

Vin=Vf(Isb)+Isb·Rm (6)

Vin=Vf(Ion1)+Ion1·Rtt1 (7)

Vin=Vf(Ion2)+Ion2·Rtt2 (8)

Vin=Vf(Ion3)+Ion3·Rtt3 (9)

In general, the forward voltage of an LED varies from part to part, and also varies depending on a current flowing therethrough. According to Equations 6-9, even if the supply voltage Vin is constant, appropriately selecting the values of four different currents, that is, the standby current Isb and the ON currents Ion1, Ion2, and Ion3, allows a desired average current to flow through the LEDs 222 and 224.

Specifically, the driver 770 changes the duty cycle based on the average current obtained by the calculator 760 so that the temporal average of the current flowing through the LEDs 222 and 224 becomes a desired value.

For example, if the value of the average current obtained by the calculator 760 is lower than a target value while the target value satisfies Ion1≧average current≧Ion2, the driver 770 increases the ON time and reduces the OFF time of the switching element 730 by means of PWM control. Thus, the average current increases and approaches the target value.

Conversely, if the value of the average current obtained by the calculator 760 is higher than a target value, the driver 770 reduces the ON time and increases the OFF time of the switching element 730 by means of PWM control. Thus, the average current decreases and approaches the target value.

For example, if the value of the average current obtained by the calculator 760 is lower than a target value while the target value satisfies Ion2≧average current≧Ion3, the driver 770 increases the ON time and reduces the OFF time of the switching element 732 by means of PWM control. Thus, the average current increases and approaches the target value.

Conversely, if the value of the average current obtained by the calculator 760 is higher than a target value, the driver 770 reduces the ON time and increases the OFF time of the switching element 732 by means of PWM control. Thus, the average current decreases and approaches the target value.

Thus, irrespective of whether the average current of the LEDs is higher or lower than a target value, the driver 770 controls the switching elements 730 and 732 so that the average current of the LEDs approaches closer to the target value. This allows the average current of the LEDs 222 and 224 to be maintained constant even when the forward voltage Vf of the LEDs 222 and 242 changes due to variation from part to part and due to the current flowing through the LEDs. Accordingly, this embodiment allows the inductance of the inductor 212 and the capacitance of the capacitor 214 to be low. This reduction achieves size reductions of the inductor 212 and of the capacitor 214, thereby further allowing a size reduction of the LED driver circuit 700. In addition, reductions in the inductance and in the capacitance also provide cost reductions in the inductor 212 and in the capacitor 214.

Further, a variation of this embodiment allows the smoothing circuit 210 to be omitted. Such an approach allows a reduction in the number of parts, thereby providing a cost reduction.

As described above, the LED driver circuit 700 shown in FIG. 7 can set four current values. Thus, assuming that one of the currents is the standby current, the average current in an LED lighting condition (i.e., a condition in which a current higher than the standby current flows through the LEDs) can be set by the other three values. Accordingly, the LED driver circuit 700 is advantageous in that it can set the current value within a smaller range than the LED driver circuit 400.

(Configuration of LED Driver Circuit 900)

FIG. 9 is a circuit diagram of an LED driver circuit 900 according to still another embodiment of the present invention. The LED driver circuit 900 includes driver units 980a and 980b each having a similar configuration to a part of the LED driver circuit 200 shown in FIG. 2.

The driver unit 980a receives a supply voltage Yin at a power supply node 902a. A capacitor 904a is provided between the power supply node 902a and ground. The power supply node 902a is coupled to a light emitting unit 920a through a smoothing circuit 910a.

The smoothing circuit 910a includes an inductor 912a and a capacitor 914a. In this embodiment, a switching operation of a switching element 930a described later allows the inductance of the inductor 912a and the capacitance of the capacitor 914a to be low. A variation of this embodiment does not necessarily need to include the smoothing circuit 910a.

The light emitting unit 920a includes LEDs 922a and 924a connected in series. The light sources of the light emitting unit 920a are not limited to LEDs, but may be any light emitting devices.

The switching element 930a is typically an FET. The switching element 930a is, for example, a power MOSFET. In this embodiment, the switching element 930a is an re-channel FET, but is not limited thereto, and may be a p-channel FET. The cathode side of the LED 924a is coupled to the drain of the switching element 930a. The source of the switching element 930a is coupled to ground through a sense resistor 940a (resistance value: Rf). The drain of the switching element 930a is coupled to ground through a resistor 942a (resistance value: Rm).

The driver unit 980b receives a supply voltage Vin at a power supply node 902b. A capacitor 904b is provided between the power supply node 902b and ground. The power supply node 902b is coupled to a light emitting unit 920b through a smoothing circuit 910b.

The smoothing circuit 910b includes an inductor 912b and a capacitor 914b. In this embodiment, a switching operation of a switching element 930b described later allows the inductance of the inductor 912b and the capacitance of the capacitor 914b to be low. A variation of this embodiment does not necessarily need to include the smoothing circuit 910b.

The light emitting unit 920b includes LEDs 922b and 924b connected in series. The light sources of the light emitting unit 920b are not limited to LEDs, but may be any light emitting devices.

The switching element 930b is typically an FET. The switching element 930b is, for example, a power MOSFET. In this embodiment, the switching element 930b is an re-channel FET, but is not limited thereto, and may be a p-channel FET. The cathode side of the LED 924b is coupled to the drain of the switching element 930b. The source of the switching element 930b is coupled to ground through a sense resistor 940b (resistance value: Rf). The drain of the switching element 930b is coupled to ground through a resistor 942b (resistance value: Rm).

The sources of the switching elements 930a and 930b are coupled to an input of an ADC 250 respectively through selectors 982a and 982b. The selectors 982a and 982b alternately change to an ON state (connecting state), thereby selectively output the source voltages of the switching elements 930a and 930b to the ADC 250.

The ADC 250 receives an input voltage, generates voltage data representing this voltage, and outputs the voltage data to a calculator 960. Typically, the voltage data represents a voltage in an 8-bit linear format, but the representation format is not limited thereto. Rather, the voltage may be represented using any suitable method.

The calculator 960 calculates a temporal average of each of currents (simply referred to herein as “average current”) flowing through the LEDs 922a, 924a, 922b, and 924b based on the voltage data generated by the ADC 250, generates current data representing these average currents, and outputs the current data to drivers 970a and 970b. Typically, the current data represents average currents in an 8-bit linear format, but the representation format is not limited thereto. Rather, the average currents may be represented using any suitable method. Thus, the calculator 960 functions as an average current computing unit.

The drivers 970a and 970b provide PWM control. Specifically, the drivers 970a and 970b drive the switching elements 930a and 930b based on the current data generated by the calculator 960. Thus, the drivers 970a and 970b function as PWM control units.

(Operation of LED Driver Circuit 900)

FIG. 10 is a waveform diagram illustrating an operation of the LED driver circuit 900. The plot (a) of FIG. 10 illustrates a current flowing through the LEDs 922a and 924a of the driver unit 980a. The plot (b) of FIG. 10 illustrates a current flowing through the LEDs 922b and 924b of the driver unit 980b. The plot (c) of FIG. 10 is a diagram illustrating the switching of the switching element 930a of the driver unit 980a. The plot (d) of FIG. 10 is a diagram illustrating the switching of the switching element 930b of the driver unit 980b. The plot (e) of FIG. 10 is a diagram illustrating the switching of the selectors 982a and 982b in the driver units 980a and 980b.

As shown in FIG. 10, the drivers 970a and 970b control the ON states and the OFF states of the switching elements 930a and 930b so that the phases of the current waveforms in the driver units 980a and 980b are shifted with respect to each other. The currents of the LEDs 922a, 924a, 922b, and 924b have the same amplitude and the same frequency. As shown in the plot (e) of FIG. 10, the selectors 982a and 982b alternately turn on the switching elements 930a and 930b, thereby allowing the common ADC 250 to determine, in a time-division manner, the currents supplied to the LEDs by the different driver units 980a and 980b.

Although, in this example, the two sets of driver units 980a and 980b are provided, providing three or more sets of driver units allows the common ADC 250 to determine, in a time-division manner, the currents supplied to the respective LEDs by the three or more sets of driver units.

Thus, this example provides a similar advantage to that described regarding the LED driver circuits 200, 400, and 700, and additionally, one ADC 250 can be shared by the plurality of driver units 980a and 980b. Accordingly, the cost of the LED driver circuit 900 can be reduced.

The LED driver circuit 900 described above includes the driver units 980a and 980b each having a similar configuration to a part of the LED driver circuit 200, but the configuration is not limited thereto. For example, the LED driver circuit 900 may include driver units 980a and 980b each having a similar configuration to a part of the LED driver circuit 400 or of the LED driver circuit 700.

In the embodiments of the present invention, each of the ADCs is coupled to a node between a switching element and a sensor resistor, and determines the voltage at the node. An average current is calculated based on the voltage determined, and is used for PWM control of the switching element. This achieves an LED driver circuit by a more simplified circuit.

The embodiments of the present invention allow each current to be set within a smaller range by using (at least three, preferably four or more) combinations of ON states and OFF states of a plurality of switching elements.

The embodiments of the present invention use 1 MHz as the switching frequency of the switching elements. However, the switching frequency is not limited thereto, and a lower frequency may be used as long as a flicker of light from the LEDs is not unpleasant for the user.

### INDUSTRIAL APPLICABILITY

The present invention is useful, for example, for LED driver circuits, light source devices, and LCD devices.

### DESCRIPTION OF REFERENCE CHARACTERS

400 LED Driver Circuit
202 Power Supply Node
204 Capacitor
210 Smoothing Circuit
212 Inductor
214 Capacitor
220 Light Emitting Unit
222, 224 LED
250 Analog-to-Digital Converter
430, 432 Switching Element
440, 441, 442 Resistor
260 Calculator
470 Driver

1. A light emitting diode (LED) driver circuit for driving a plurality of LEDs, comprising:
a first switching element;
a second switching element;
a sense resistor;
a sensing unit;
a calculator; and
a driver,
wherein
the plurality of LEDs, the first switching element, the second switching element, and the sense resistor are coupled to each other in series in this order,
the sensing unit receives a voltage at a node between the second switching element and the sense resistor, and generates voltage data representing the voltage,
the calculator calculates a temporal average of a current flowing through the plurality of LEDs based on the voltage data, and generates current data corresponding to the temporal average, and
the driver drives the first switching element and the second switching element based on the current data.

2. The LED driver circuit of claim 1, further comprising:
a smoothing circuit coupled to the plurality of LEDs and having an inductor and a capacitor.

3. The LED driver circuit of claim 1, comprising:
a plurality of units each having
the plurality of LEDs,
the first switching element,
the second switching element, and
the sense resistor,
wherein
the sensing unit is time shared by the plurality of units.

4. An LED driver circuit for driving a plurality of LEDs, comprising:
a first switching element;
a second switching element;
a first sense resistor;
a second sense resistor;
a sensing unit;
a calculator; and
a driver,
wherein
the first switching element and the first sense resistor are coupled to each other in series to form a first unit,
the second switching element and the second sense resistor are coupled to each other in series to form a second unit,
the first unit and the second unit are coupled to each other in parallel to form a third unit,
the plurality of LEDs and the third unit are coupled to each other in series,
the sensing unit receives a first voltage at a node between the first switching element and the first sense resistor, and generates first voltage data representing the first voltage,
the sensing unit receives a second voltage at a node between the second switching element and the second sense resistor, and generates second voltage data representing the second voltage,
the calculator calculates a temporal average of a current flowing through the plurality of LEDs based on the first voltage data and on the second voltage data, and generates current data corresponding to the temporal average, and
the driver drives the first switching element and the second switching element based on the current data.

5. The LED driver circuit of claim 4, further comprising:
a smoothing circuit coupled to the plurality of LEDs and having an inductor and a capacitor.

6. The LED driver circuit of claim 4, comprising:
a plurality of units each having
the plurality of LEDs,
the first switching element,
the second switching element,
the first sense resistor, and
the second sense resistor,
wherein
the sensing unit is time shared by the plurality of units.

7. A light source device, comprising:
a plurality of LEDs; and
the LED driver circuit of claim 1 for driving the plurality of LEDs.

8. A liquid crystal display (LCD) device, comprising:
a plurality of LEDs;
the LED driver circuit of claim 1 for driving the plurality of LEDs; and
an LCD panel disposed opposite the plurality of LEDs.
